(19) United States
(12) Patent Application Publication
(10) Pub. No.: US 2019/0265747 A1
(43) Pub. Date: Aug. 29, 2019

(54) SHIFT DEVICE

(71) Applicant: KABUSHIKI KAISHA TOKAI-RIKA-DENKI-SEISAKUSHO, Aichi-ken (JP)

(72) Inventor: Makoto YAMAMOTO, Aichi-ken (JP)

(21) Appl. No.: 16/279,287

(22) Filed: Feb. 19, 2019

(30) Foreign Application Priority Data
Feb. 23, 2018 (JP) 2018-031090

(51) Int. Cl. G05G 5/02; G05G 5/04; G05G 1/04; F16H 59/02

(52) U.S. Cl. CPC G05G 5/02; G05G 5/04; G05G 1/04; F16H 2059/026; G05G 2700/02; F16H 2059/0221; F16H 59/02

(57) ABSTRACT

In a shift device, rotational movement of a lever in a left and right direction is restricted by control of a motor. Rotational movement of the lever in a front and rear direction is also restricted by control of the motor. Therefore, rotational movements of the lever in the left and right direction and in the front and rear direction can be restricted by control of the single motor. Thus, structure of the restricting mechanism can be simplified.

### CROSS-REFERENCE TO RELATED APPLICATION

This application claims priority under 35 USC 119 from Japanese Patent Application No. 2018-031090 filed Feb. 23, 2018, the disclosure of which is incorporated by reference herein.

### BACKGROUND

### Field of the Invention

The present disclosure relates to a shift device in which a shift body is moved and a shift position of the shift body is changed.

### Related Art

In a lock device recited in Japanese Patent Application Laid-Open (JP-A) No. H8-93897, by controlling to a solenoid, a first lock piece restricts movement of a shift lever in a left and right direction from a neutral position N to a reverse position R, and a second lock piece restricts movement of the shift lever in the left and right direction from a park position P to the reverse position R.

In this lock device, movements of the shift lever in the left and right direction are restricted by controlling to the solenoid. The first lock piece restricts movement of the shift lever from the neutral position N to the reverse position R, and the second lock piece restricts movement of the shift lever from the park position P to the neutral position N.

### SUMMARY

In consideration of the circumstances described above, the present disclosure provides a shift device in which structure of a restricting mechanism may be simplified.

A shift device according to a first aspect of the present disclosure includes: a shift body that is moved in at least one of one direction or another direction that is orthogonal to the one another, to change a shift position of the shift body; and a restricting mechanism at which a driving device is provided, the restricting mechanism restricting movement of the shift body in the one direction by controlling the driving device, and the restricting mechanism restricting movement of the shift body in the another direction by controlling the driving device.

A shift device according to a second aspect of the present invention includes: a shift body that is moved to change a shift position of the shift body; and a restricting mechanism at which a restricting member is provided, the restricting mechanism restricting movement of the shift body from a first shift position to a second shift position due to the restricting member being disposed at a first position, and the restricting mechanism restricting movement of the shift body from the second shift position to the first shift position due to the restricting member being disposed at a second position.

In a shift device according to a third aspect of the present invention, in the shift device according to the second aspect of the present invention, the first shift position and the second shift position are adjacently provided.

In the shift device according to the first aspect of the present disclosure, the shift body is moved in the one direction and/or in the another direction that are orthogonal to one another and the shift position of the shift body is changed.

The driving device is provided at the restricting mechanism. Movement of the shift body in the one direction is restricted by controlling of the driving device, and movement of the shift body in the another direction is also restricted by controlling of the driving device. Therefore, movements of the shift body in the one direction and/or in the another direction can be restricted by controlling of the driving device. Thus, the structure of the restricting mechanism may be simplified.

In the shift device according to the second aspect of the present disclosure, the shift body is moved and the shift position of the shift body is changed.

The restricting member is provided at the restricting mechanism. The restricting member is caused to be disposed at the first position to restrict movement of the shift body from the first shift position to the second shift position, and the restricting member is cause to be disposed at the second position to restrict movement of the shift body from the second shift position to the first shift position. Therefore, the restricting member can restrict movements of the shift body from the first shift position to the second shift position and from the second shift position to the first shift position. Thus, structure of the restricting mechanism may be simplified.

In the shift device according to the third aspect of the present disclosure, the first shift position and the second shift position are adjacently provided. Changing the disposition location of the restricting member between the first position and the second position changes between a portion of the restricting member that restricts movement of the shift body from the first shift position to the second shift position and a portion of the restricting member that restricts movement of the shift body from the second shift position to the first shift position. Therefore, even though the first shift position and the second shift position are adjacently provided, a restriction strength against movement of the shift body from the first shift position to the second position and a restriction strength against movement of the shift body from the second shift position to the first shift position can be increased.

### BRIEF DESCRIPTION OF THE DRAWINGS

An exemplary embodiment will be described in detail with reference to the following figures, wherein:

FIG. 1 is a sectional view, seen from the left, showing a shift device according to the exemplary embodiment of the present disclosure.

FIG. 2A is a rear view, seen from the rear, showing principal portions of the shift device according to the exemplary embodiment of the present disclosure.

FIG. 2B is a plan view, seen from upward, showing an arrangement of shift positions of a lever of the shift device according to the exemplary embodiment of the present disclosure.

FIG. 3A to FIG. 3C are sectional views showing states in which the lever of the shift device according to the exemplary embodiment of the present disclosure is disposed at a P position. FIG. 3A is a view seen from upward, FIG. 3B is a view seen from the front showing a situation in which rotational movement of the lever toward an R position is allowed, and FIG. 3C is a view seen from the front showing a situation in which rotational movement of the lever toward the R position is restricted.

FIG. 4A to FIG. 4C are sectional views showing states in which the lever of the shift device according to the exemplary embodiment of the present disclosure is disposed at the R position. FIG. 4A is a view seen from upward, FIG. 4B is a view seen from the front showing a situation in which rotational movement of the lever toward the P position is allowed, and FIG. 4C is a view seen from the front showing a situation in which rotational movement of the lever toward the P position is restricted.

FIG. 5A to FIG. 5C are sectional views showing states in which the lever of the shift device according to the exemplary embodiment of the present disclosure is disposed at an N position. FIG. 5A is a view seen from upward, FIG. 5B is a view seen from the right showing a situation in which rotational movement of the lever toward the R position is allowed, and FIG. 5C is a view seen from the right showing a situation in which rotational movement of the lever toward the R position is restricted.

FIG. 6A to FIG. 6C are sectional views showing states in which the lever of the shift device according to the exemplary embodiment of the present disclosure is disposed at a D position. FIG. 6A is a view seen from upward, FIG. 6B is a view seen from the right showing a situation in which rotational movement of the lever toward the R position is allowed, and FIG. 6C is a view seen from the right showing a situation in which rotational movement of the lever toward the R position is restricted.

FIG. 7A is a graph showing a relationship between a rotational position of a cam (the horizontal axis) and an upper and lower direction position of a lock piece (the vertical axis) of the shift device according to the exemplary embodiment of the present disclosure.

FIG. 7B is a rear view, seen from the rear, illustrating the relationship between the rotational position of the cam and the upper and lower direction position of the lock piece of the shift device according to the exemplary embodiment of the present disclosure.

### DETAILED DESCRIPTION

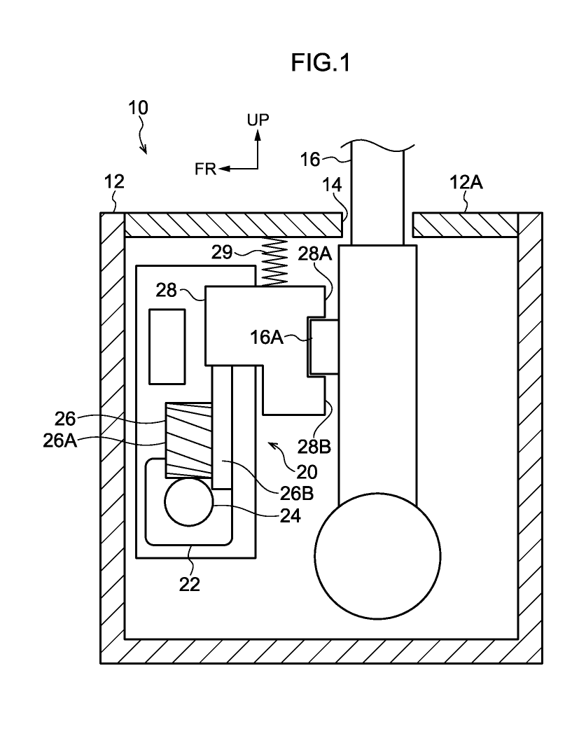

FIG. 1 is a sectional view, seen from the left, showing a shift device 10 according to an exemplary embodiment of the present disclosure. In the drawings, a front direction of the shift device 10 is indicated by arrow FR, a right direction of the shift device 10 is indicated by arrow RH, and an upper direction of the shift device 10 is indicated by arrow UP.

The shift device 10 according to the present exemplary embodiment is disposed at a console (not shown in the drawings) of a vehicle (a car). The front, right and upper sides of the shift device 10 are oriented to, respectively, the front, right and upper sides of the vehicle.

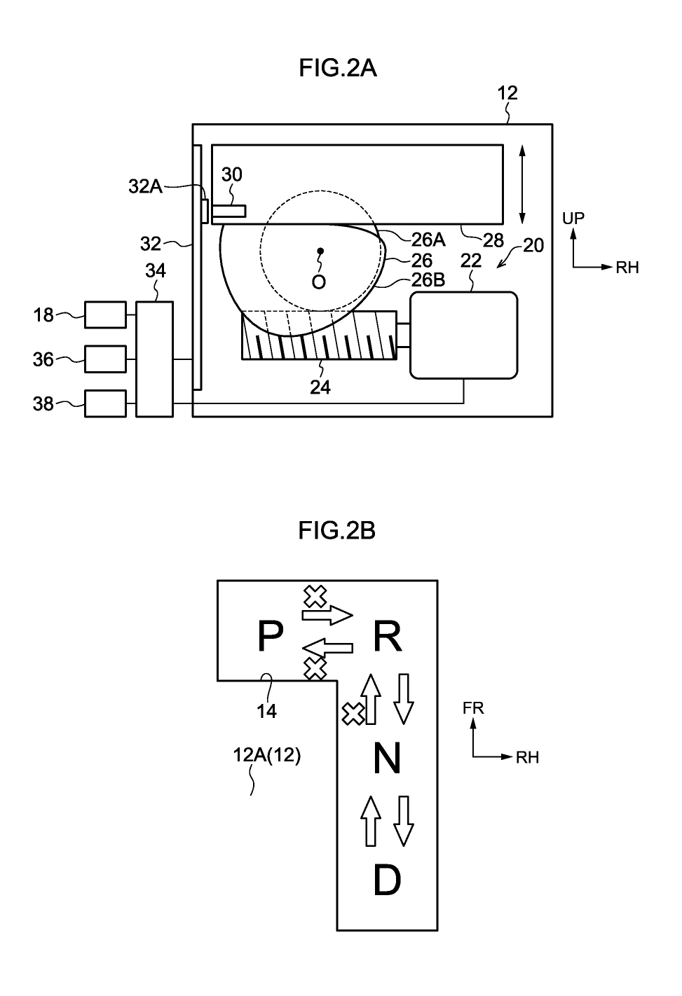

As shown in FIG. 1, a substantially cuboid box-shaped plate 12 is provided at the shift device 10. The plate 12 is fixed inside the console, disposing the shift device 10 at the console (not shown in the drawings). An upper wall of the plate 12 is formed as a substantially rectangular plate-shaped strength gate 12A that serves as a guide member. A restricting slot (groove) 14 with an “L” shape in plan view (see FIG. 2B) is formed penetrating through the strength gate 12A. The restricting slot 14 serves as a guide portion. A front side portion of the restricting slot 14 extends in the left and right direction, and a rear side portion of the restricting slot 14 extends in the front and rear direction from the rear side of a right end portion of the front side portion.

A lower end portion (base end portion) of a lever 16 substantially in a long rod shape is supported at a lower end portion of the interior of the plate 12. The lever 16 serves as a shift body (an operation body). The lever 16 is rotationally movable (movable) about the lower end portion thereof in the front and rear direction (one direction, which is a shift direction) and the left and right direction (another direction, which is a select direction). The lever 16 penetrates through the restricting slot 14 of the strength gate 12A. The lever 16 is guided by the restricting slot 14 and rotationally moves along the restricting slot 14, and this rotational movement is restricted by peripheral faces of the restricting slot 14 (see FIG. 2B). When the lever 16 is disposed at a left end portion or right portion of the front side portion of the restricting slot 14, the lever 16 is disposed at, respectively, a P position (a park position, which is a first shift position) or an R position (a reverse position, which is a second shift position). The P position and R position serve as shift positions. When the lever 16 is disposed at a front portion or a rear end portion of the rear side portion of the restricting slot 14, the lever 16 is disposed at, respectively, an N position (a neutral position, which is a third shift position) or a D position (a drive position). The N position and D position also serve as shift positions.

The lever 16 extends and protrudes to the upper side from the plate 12. Thus, an upper portion of the lever 16 extends into a vehicle cabin from the console. A knob (not shown in the drawings) that serves as a gripped portion is provided at an upper end portion (distal end portion) of the lever 16. In a state in which the knob is gripped by an occupant of the vehicle (in particular, a driver), the lever 16 can be operated by rotational movements in the front and rear direction and the left and right direction. A switch 18 (see FIG. 2A) is provided at the knob to serve as an operation portion. The switch 18 can be operated by the occupant.

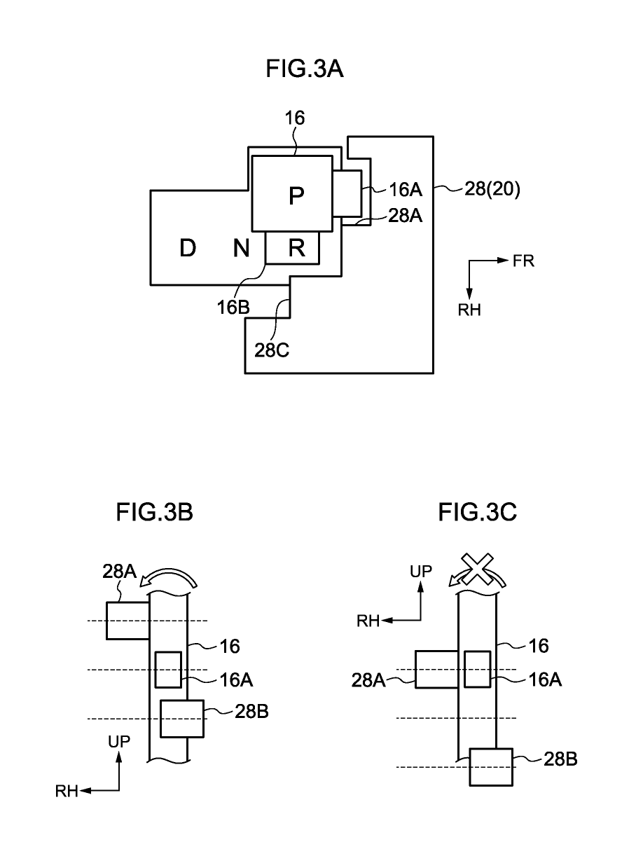

A first protrusion 16A in a cuboid shape that serves as a first restricted portion is provided at the lever 16, at the lower side of the strength gate 12A. The first protrusion 16A protrudes to the front side. A second protrusion 16B in a cuboid shape (see FIG. 3A) that serves as a second restricted portion is provided at the lever 16, at the lower side of the strength gate 12A. The second protrusion 16B protrudes to the right side. An upper and lower direction position of the second protrusion 16B is the same as an upper and lower direction position of the first protrusion 16A.

A restricting mechanism 20 (a lock mechanism; see FIG. 2A) is provided inside the plate 12 at the front side of the lever 16.

A motor 22 that serves as a driving device is provided at the restricting mechanism 20. The motor 22 is fixed to a lower portion of the interior of the plate 12. A worm gear 24 is coaxially fixed to an output shaft of the motor 22. When the motor 22 drives, the worm gear 24 is rotated.

A cam body 26 is provided at the upper side of the worm gear 24. The cam body 26 is supported inside the plate 12 to be rotatable. A cam gear 26A (a worm wheel) is provided at the cam body 26 so as to be integrally rotatable. A central axis of the cam gear 26A matches a rotation center axis O of the cam body 26. The cam gear 26A meshes with the worm gear 24. Thus, when the worm gear 24 is rotated, thereby the cam gear 26A is rotated and the cam body 26 is rotated. A cam 26B in a substantially semicircular plate shape is provided at the cam body 26 so as to be integrally rotatable. The cam 26B is offset relative to the rotation center axis O of the cam body 26.

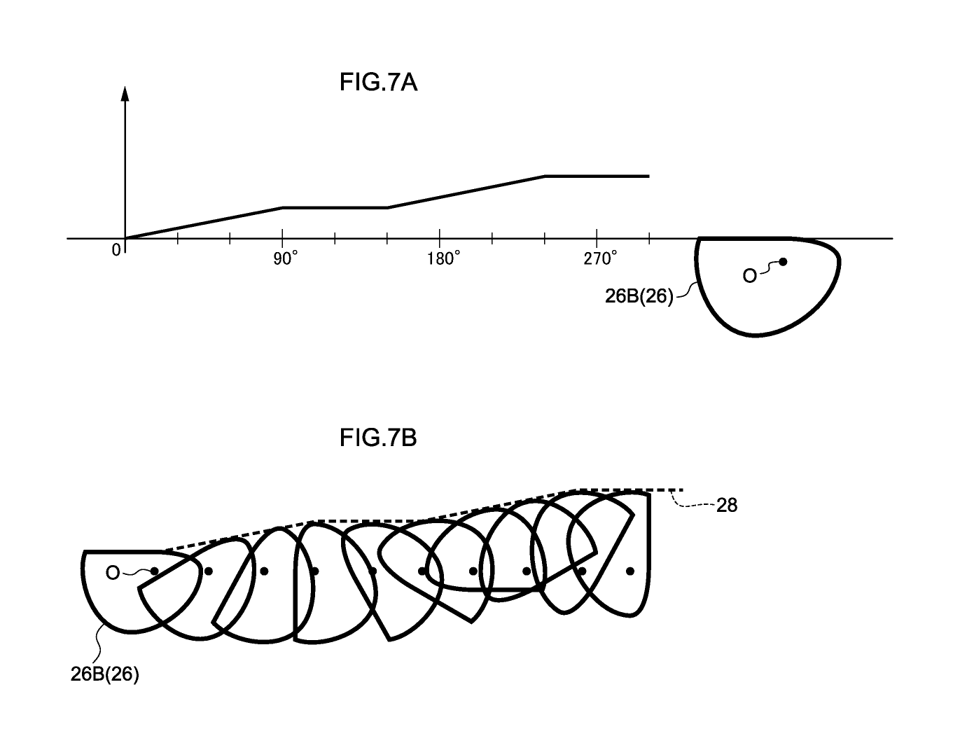

A block-shaped lock piece 28 that serves as a restricting member is provided at the upper side of the cam body 26. The lock piece 28 is supported to be movable (slidable) in the upper and lower direction inside the plate 12. The lock piece 28 is urged toward the lower side by a spring 29 (a compression coil spring) at the upper side that serves as an urging portion. The lock piece 28 abuts against the cam 26B of the cam body 26 from the upper side thereof. Thus, when the cam 26B is rotated, thereby the lock piece 28 is moved to the upper side by the cam 26B (in opposition to the urging force of the spring 29), and is moved to the lower side by the urging force of the spring 29 (see FIG. 7A and FIG. 7B). Accordingly, the lock piece 28 can be disposed at a lower position at the lower side, which serves as a first position (a restricting position), an upper position at the upper side, which serves as a second position (a restricting position), and a middle position therebetween in the upper and lower direction, which serves as a third position (a release position).

The lock piece 28 is formed substantially in an “L” shape in plan view. The lock piece 28 is disposed at the front side and right side of the restricting slot 14 of the strength gate 12A. A magnet 30 that serves as a detected portion is fixed to a left end portion of the lock piece 28. The magnet 30 is movable in the upper and lower direction integrally with the lock piece 28.

A first restricting portion 28A in a cuboid shape (see FIG. 3A to FIG. 3C) is provided at the rear side of a left and right direction middle portion of front side portion of the lock piece 28. The first restricting portion 28A protrudes to the rear side, and portions between a right face and front face of the lock piece 28 are solid (continuous with the lock piece 28).

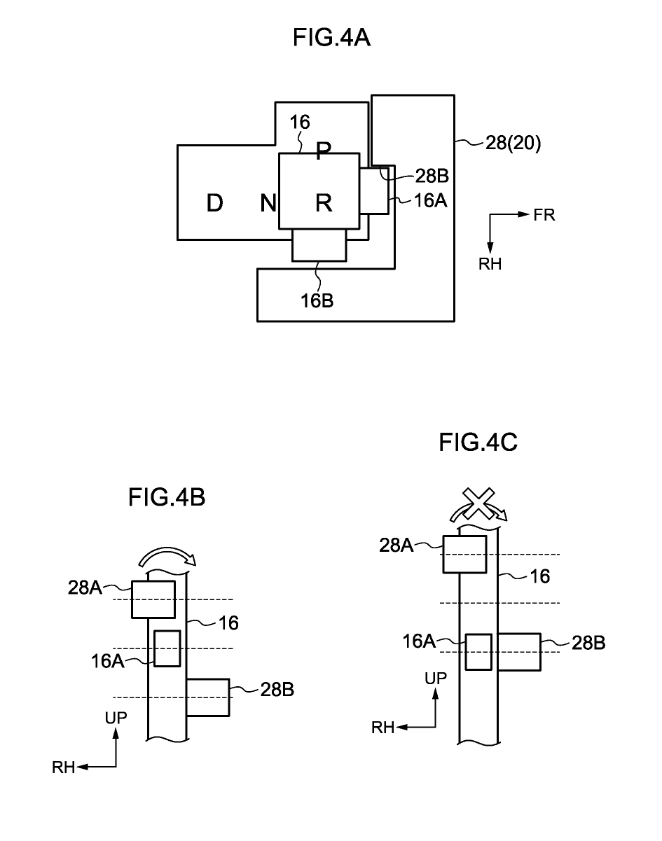

A second restricting portion 28B in a cuboid shape (see FIG. 4A to FIG. 4C) is provided at the rear side of a left portion of the front side portion of the lock piece 28. The second restricting portion 28B protrudes to the rear side, and portions between left face and front face of the lock piece 28 are solid (continuous with the lock piece 28). The second restricting portion 28B is disposed at the left side and at the lower side of the first restricting portion 28A. A spacing between the first restricting portion 28A and the second restricting portion 28B has a larger upper and lower direction dimension than an upper and lower direction dimension of the first protrusion 16A of the lever 16 and has a smaller left and right direction dimension than a left and right direction dimension of the first protrusion 16A.

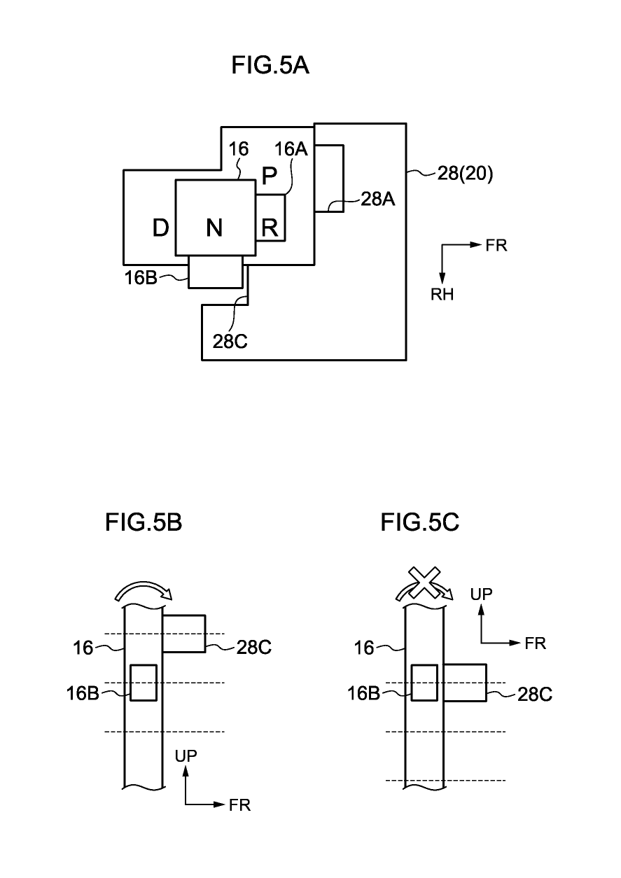

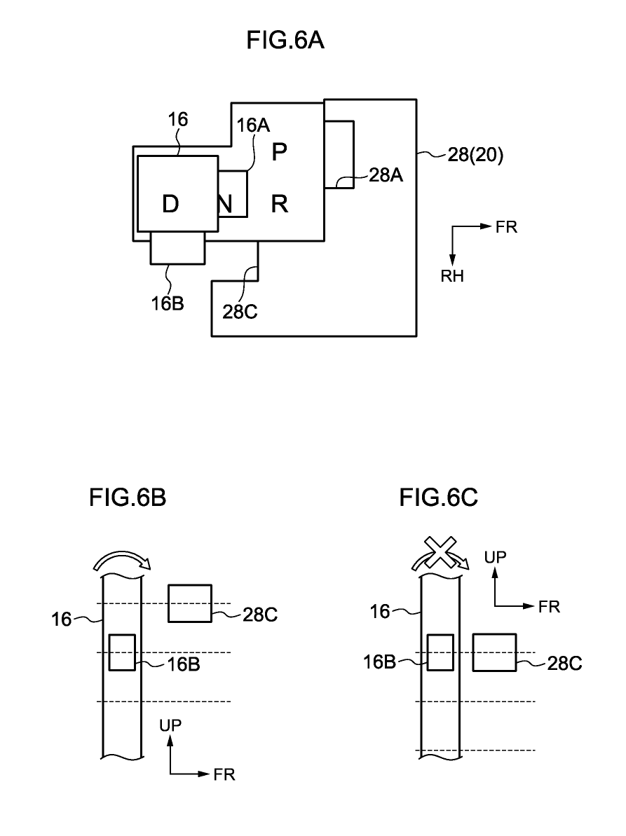

A third restricting portion 28C in a cuboid shape (see FIG. 5A to FIG. 6C) is provided at the left side of a front portion of a rear side portion of the lock piece 28. The third restricting portion 28C protrudes to the left side, and portions between front face and right face of the lock piece 28 are solid (continuous with the lock piece 28). The third restricting portion 28C is disposed at the rear side and at the right side of the first restricting portion 28A. An upper and lower direction position of the third restricting portion 28C matches an upper and lower direction position of the first restricting portion 28A.

A sensor baseboard (substrate) 32 (see FIG. 2A) that serves as a position detection mechanism is fixed inside the plate 12. The sensor baseboard 32 is disposed at the left side of the lock piece 28 of the restricting mechanism 20 to be perpendicular to the left and right direction. A sensor 32A (for example, a Hall effect IC) that serves as a detection portion is provided at the sensor baseboard 32. The sensor 32A detects upper and lower direction positions of the magnet 30 of the lock piece 28, thus detecting upper and lower direction positions of the lock piece 28.

The sensor baseboard 32 (and the sensor 32A) is electronically connected to a control device 34 of the vehicle (see FIG. 2A). The switch 18 of the lever 16 and the motor 22 of the restricting mechanism 20 are also electronically connected to the control device 34. A shift sensor 36 (see FIG. 2A) that serves as a shift detection mechanism, which is electronically connected to the control device 34, detects rotational movement positions of the lever 16 in the front and rear direction and the left and right direction, thus detecting shift positions of the lever 16. A brake 38 of the vehicle (see FIG. 2A) is electronically connected to the control device 34. When the brake 38 is operated by an occupant, the vehicle brakes.

Now, operation of the present exemplary embodiment is described.

In the shift device 10 with the structure described above, the lever 16 is rotationally moved to the right side from the P position and disposed at the R position. The lever 16 is then rotationally moved to the rear side from the R position and disposed at, successively, the N position and the D position.

On the basis of upper and lower direction positions of the lock piece 28 of the restricting mechanism 20 that are detected by the sensor baseboard 32 (the sensor 32A), the control device 34 controls driving of the motor 22 of the restricting mechanism 20. Thus, in the restricting mechanism 20, the cam body 26 (the cam gear 26A and cam 26B) is rotated via the worm gear 24, and the lock piece 28 is disposed at the lower position, the upper position or the middle position.

In a situation (state) in which the brake 38 is operated when the lever 16 is disposed at the P position (i.e., when the shift sensor 36 detects that the lever 16 is disposed at the P position), if the switch 18 of the lever 16 (the knob) is not operated, the motor 22 is driven by control from the control device 34 and the lock piece 28 is disposed at the lower position (see FIG. 3C). Namely, the first restricting portion 28A of the lock piece 28 is disposed at the right side of the first protrusion 16A of the lever 16, and is disposed at the substantially the same position of the first protrusion 16A of the lever 16 in the upper and lower direction (so as to be able to abut at least partially in the left and right direction). Consequently, the first restricting portion 28A of the lock piece 28 restricts rotational movement of the first protrusion 16A of the lever 16 to the right side, restricting rotational movement of the lever 16 to the right side. Thus, rotational movement of the lever 16 from the P position to the R position is restricted (locked).

On the other hand, if the switch 18 is operated in the situation (state) in which the brake 38 is operated when the lever 16 is disposed at the P position (i.e., when the shift sensor 36 detects that the lever 16 is disposed at the P position), the motor 22 is driven by control from the control device 34 and the lock piece 28 is disposed at the middle position (see FIG. 3B). Namely, the first restricting portion 28A of the lock piece 28 is disposed at the right side of the first protrusion 16A of the lever 16, but is disposed at a different position from a position of the first protrusion 16A of the lever 16 in the upper and lower direction. Consequently, the first restricting portion 28A of the lock piece 28 allows rotational movement of the first protrusion 16A of the lever 16 to the right side, allowing rotational movement of the lever 16 to the right side. Thus, rotational movement of the lever 16 from the P position to the R position is allowed (unlocked).

If the switch 18 is not operated in a situation (state) in which the brake 38 is operated when the lever 16 is disposed at the R position (i.e., when the shift sensor 36 detects that the lever 16 is disposed at the R position), the motor 22 is driven by control from the control device 34 and the lock piece 28 is disposed at the upper position (see FIG. 4C). Namely, the second restricting portion 28B of the lock piece 28 is disposed at the left side of the first protrusion 16A of the lever 16, and is disposed at the substantially the same position of the first protrusion 16A of the lever 16 in the upper and lower direction (so as to be able to abut at least partially in the left and right direction). Consequently, the second restricting portion 28B of the lock piece 28 restricts rotational movement of the first protrusion 16A of the lever 16 to the left side, restricting rotational movement of the lever 16 to the left side. Thus, rotational movement of the lever 16 from the R position to the P position is restricted.

On the other hand, if the switch 18 is operated in the situation (state) in which the brake 38 is operated when the lever 16 is disposed at the R position (i.e., when the shift sensor 36 detects that the lever 16 is disposed at the R position), the motor 22 is driven by control from the control device 34 and the lock piece 28 is disposed at the middle position (see FIG. 4B). Namely, the second restricting portion 28B of the lock piece 28 is disposed at the left side of the first protrusion 16A of the lever 16, but is disposed at a different position from a position of the first protrusion 16A of the lever 16 in the upper and lower direction. Consequently, the second restricting portion 28B of the lock piece 28 allows rotational movement of the first protrusion 16A of the lever 16 to the left side, allowing rotational movement of the lever 16 to the left side. Thus, rotational movement of the lever 16 from the R position to the P position is allowed.

If the switch 18 is not operated in a situation (state) in which the brake 38 is operated when the lever 16 is disposed at the N position or the D position (i.e., when the shift sensor 36 detects that the lever 16 is disposed at the N position or D position), the motor 22 is driven by control from the control device 34 and the lock piece 28 is disposed at the lower position (see FIG. 5C and FIG. 6C). Namely, the third restricting portion 28C of the lock piece 28 is disposed at the front side of the second protrusion 16B of the lever 16, and is disposed at the substantially the same position of the second protrusion 16B of the lever 16 in the upper and lower direction (so as to be able to abut at least partially in the front and rear direction). Consequently, the third restricting portion 28C of the lock piece 28 restricts rotational movement of the second protrusion 16B of the lever 16 to the front side, restricting rotational movement of the lever 16 to the front side. Thus, rotational movement of the lever 16 from the N position to the R position is restricted.

On the other hand, if the switch 18 is operated in the situation (state) in which the brake 38 is operated when the lever 16 is disposed at the N position or the D position (i.e., when the shift sensor 36 detects that the lever 16 is disposed at the N position or D position), the motor 22 is driven by control from the control device 34 and the lock piece 28 is disposed at the middle position (see FIG. 5B and FIG. 6B). Namely, the third restricting portion 28C of the lock piece 28 is disposed at the front side of the second protrusion 16B of the lever 16, but is disposed at a different position from a position of the second protrusion 16B of the lever 16 in the upper and lower direction. Consequently, the third restricting portion 28C of the lock piece 28 allows rotational movement of the second protrusion 16B of the lever 16 to the front side, allowing rotational movement of the lever 16 to the front side. Thus, rotational movement of the lever 16 from the N position to the R position is allowed.

As described above, rotational movement of the lever 16 in the left and right direction (right side rotational movement from the P position to the R position and left side rotational movement from the R position to the P position) is restricted by the control device 34 controlling the motor 22, and rotational movement of the lever 16 in the front and rear direction (front side rotational movement from the N position to the R position) is restricted by the control device 34 controlling the motor 22. Therefore, rotational movements of the lever 16 in the left and right direction and in the front and rear direction can be restricted in accordance with control of the single motor 22 by the control device 34. As a result, there is no need to provide plural motors 22 in order to restrict rotational movements of the lever 16 in the left and right direction and in the front and rear direction. Thus, the structure of the restricting mechanism 20 can be simplified.

Also as described above, the lock piece 28 (the first restricting portion 28A) is disposed at the lower position to restrict rotational movement of the lever 16 (the first protrusion 16A) from the P position to the R position, and the lock piece 28 (the second restricting portion 28B) is disposed at the upper position to restrict rotational movement of the lever 16 (the first protrusion 16A) from the R position to the P position. Therefore, rotational movements of the lever 16 from the P position to the R position and from the R position to the P position can be restricted by the single lock piece 28. As a result, there is no need to provide plural lock pieces 28 in order to restrict rotational movements of the lever 16 from the P position to the R position and from the R position to the P position. Thus, the structure of the restricting mechanism 20 can be simplified.

The P position and the R position are shift positions that are adjacently provided (provided so as to be next position to each other in the left and right direction). Changing the disposition location of the lock piece 28 between the lower position and the upper position, thereby changing is performed between the portion of the lock piece 28 that restricts rotational movement of the lever 16 (the first protrusion 16A) from the P position to the R position (i.e., the first restricting portion 28A) and the portion of the lock piece 28 that restricts rotational movement of the lever 16 (the first protrusion 16A) from the R position to the P position (i.e., the second restricting portion 28B. Therefore, even though the P position and the R position are shift positions that are adjacently provided, strengths of the first restricting portion 28A and second restricting portion 28B of the lock piece 28 in the left and right direction (the direction in which the P position and the R position are adjacent) can be increased. Thus, a restriction strength against rotation of the lever 16 from the P position to the R position (the left and right direction strength of the first restricting portion 28A) and a restriction strength against rotation of the lever 16 from the R position to the P position (the left and right direction strength of the second restricting portion 28B) can be increased.

In the present exemplary embodiment, when the switch 18 of the lever 16 is operated in a situation (state) in which the brake 38 is operated, the lock piece 28 is moved to the middle position and rotational movement of the lever 16 is allowed (the restriction is released). However, the lock piece 28 may be moved to the middle position, allowing rotational movement of the lever 16 (releasing the restriction), only (just) by the brake 38 being operated. Further, the lock piece 28 may be moved to the middle position, allowing rotational movement of the lever 16 (releasing the restriction), both in accordance with the brake 38 being operated and in accordance with a vehicle speed condition.

In the present exemplary embodiment, the first shift position and the second shift position are the P position and the R position, and are shift positions that are adjacently provided. However, another shift position may be interposed between the first shift position and the second shift position.

In the present exemplary embodiment, the lever 16 is rotationally movable in the front and rear direction and in the right and left direction. However the lever may be rotationally movable only in the front and rear direction (the one direction).

In the present exemplary embodiment, the lever 16 (the shift body) is rotationally moved. However, the shift body may be rotated about a central axis or may be slidingly moved.

In the present exemplary embodiment, the shift device 10 is disposed at a console. However, the shift device 10 may be disposed at a floor portion of a vehicle cabin, an instrument panel or a steering column.

What is claimed is:

1. A shift device comprising:
a shift body that is moved in at least one of one direction or another direction that is orthogonal to the one another, to change a shift position of the shift body; and
a restricting mechanism at which a driving device is provided, the restricting mechanism restricting movement of the shift body in the one direction by controlling the driving device, and the restricting mechanism restricting movement of the shift body in the another direction by controlling the driving device.

2. A shift device comprising:
a shift body that is moved to change a shift position of the shift body; and
a restricting mechanism at which a restricting member is provided, the restricting mechanism restricting movement of the shift body from a first shift position to a second shift position due to the restricting member being disposed at a first position, and the restricting mechanism restricting movement of the shift body from the second shift position to the first shift position due to the restricting member being disposed at a second position.

3. The shift body of claim 2, wherein the first shift position and the second shift position are adjacently provided.
